(19) United States
(12) Patent Application Publication
(10) Pub. No.: US 2024/0400211 A1
(43) Pub. Date: Dec. 5, 2024

(54) Augmentable Air Injected Plenum Propulsion Drive for Electric VTOL Operation and Flight

(71) Applicant: George Fitzgerald Washington, Blythewood, SC (US)

(72) Inventor: George Fitzgerald Washington, Blythewood, SC (US)

(21) Appl. No.: 18/328,755

(22) Filed: Jun. 4, 2023

(51) Int. Cl. B64D 27/24

(52) U.S. Cl. CPC B64D 27/24; B64U 10/20; B64C 29/0008; B64C 29/0066

(57) ABSTRACT

Here on Earth, there is a need and is quite essential that we keep moving. But we must be progressive in our living and livelihood while protecting and preserving our planet. There are places to go, people to meet, and business to be had. Designed with electric aircraft and flying cars or taxis in mind, the Augmentable Air Injected Plenum Propulsion Drive for Electric VTOL Operation and Flight is the first electric VTOL propulsion system to employ the concept of opposing air flow and cyclic column compression of those opposing flow(s) to pressurize a plenum chamber. Opposing flow and cyclic column compression is then harnessed for the purpose of augmenting, or amplifying, injected air to provide enhanced air/fluid power to an electric VTOL thrust system for the purpose of VTOL operation and horizontal flight and is multi-modal for VTOL and horizontal flight.

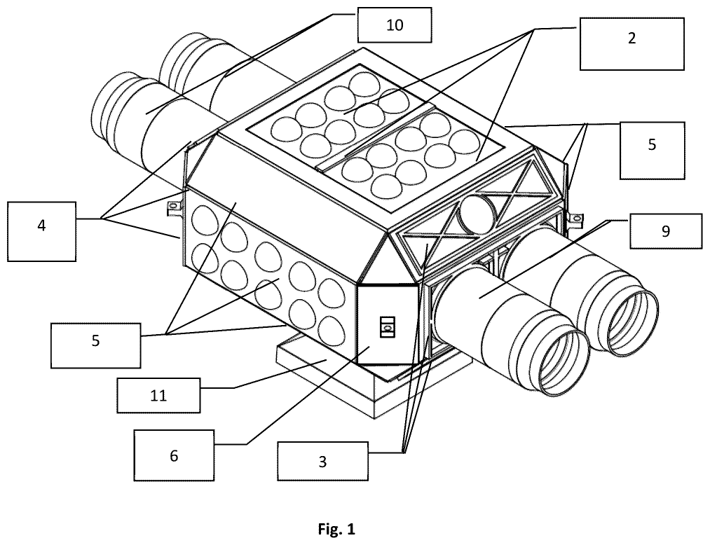

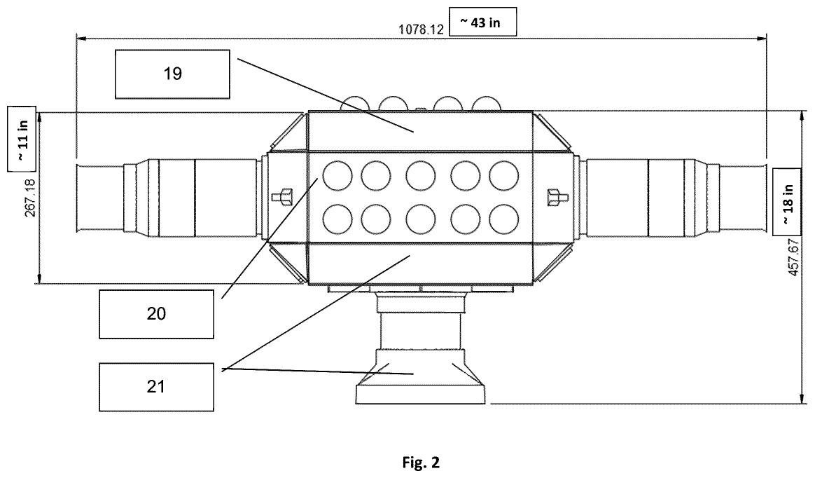

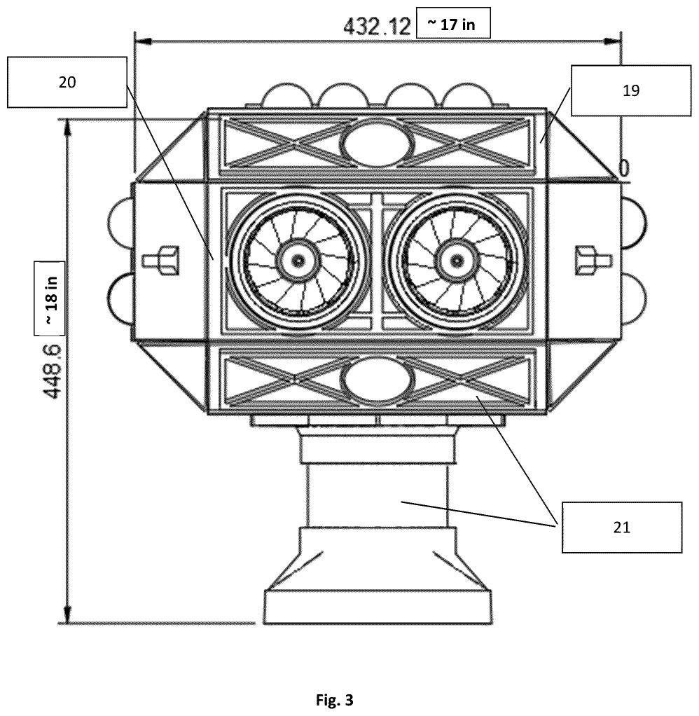

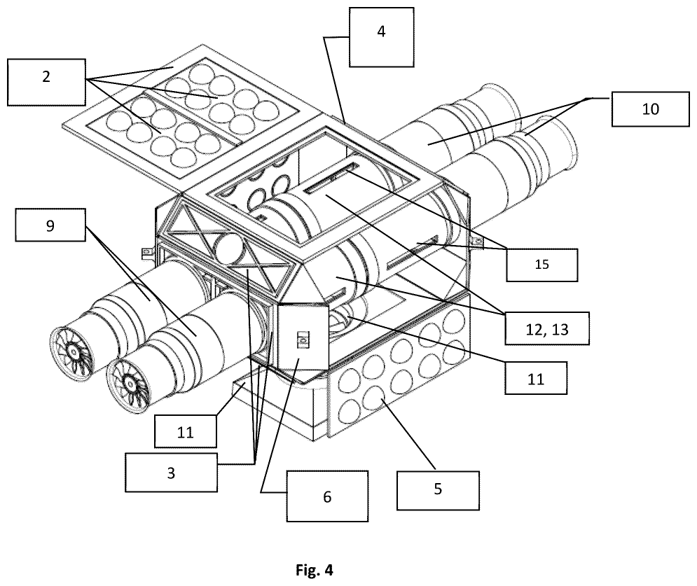

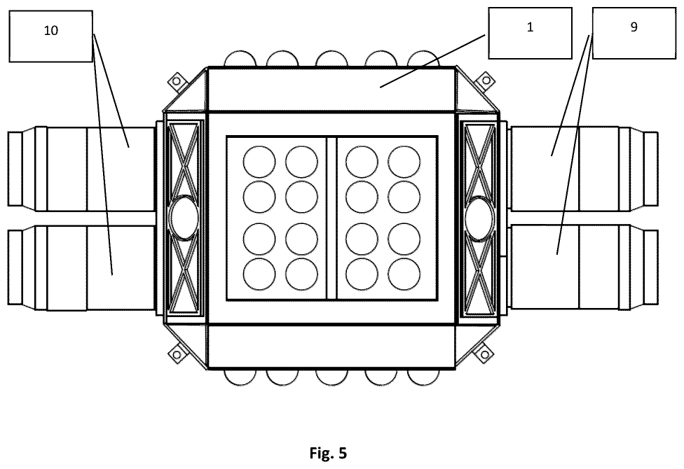

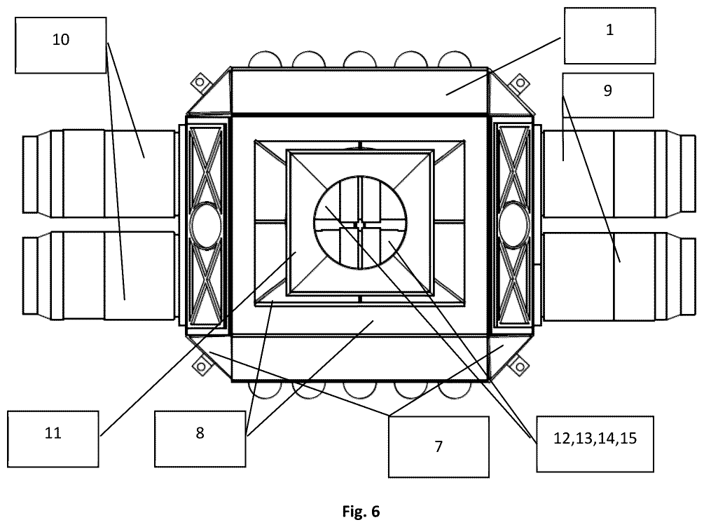

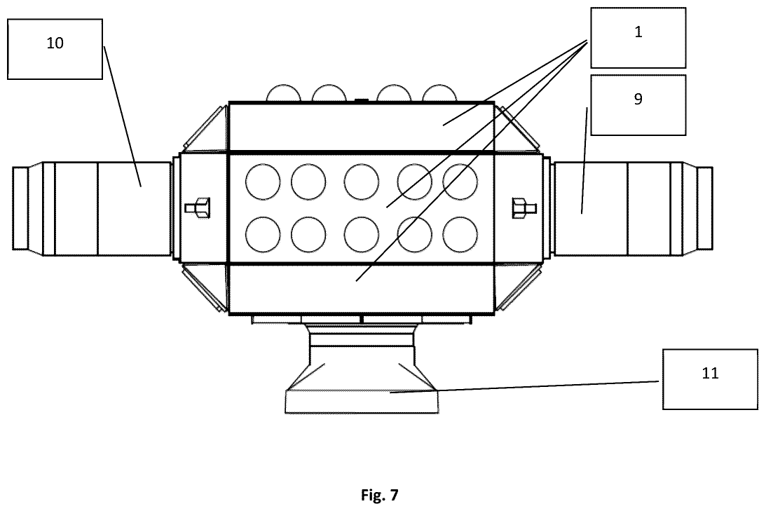

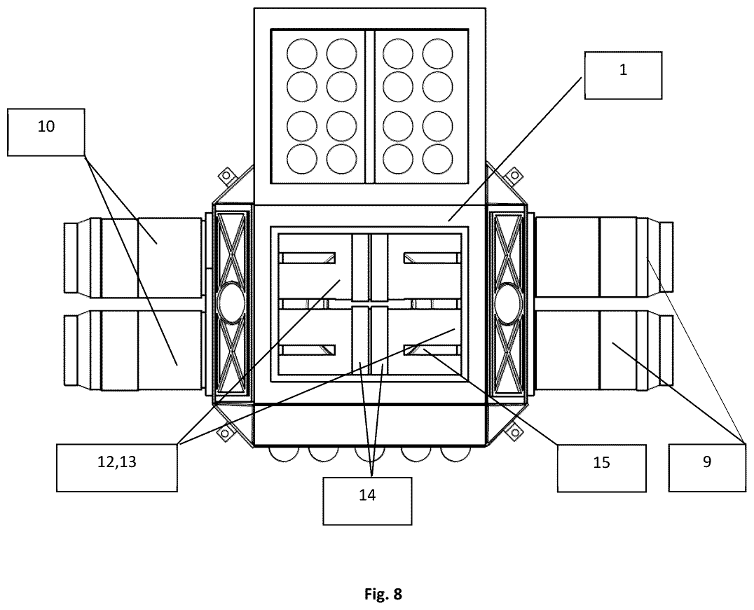

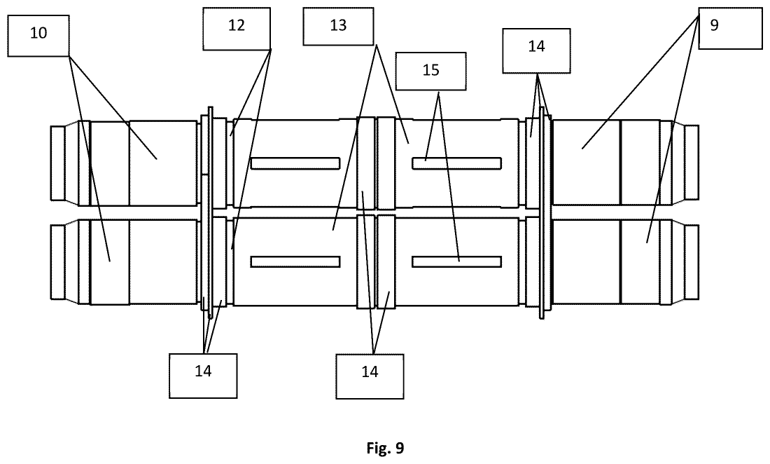

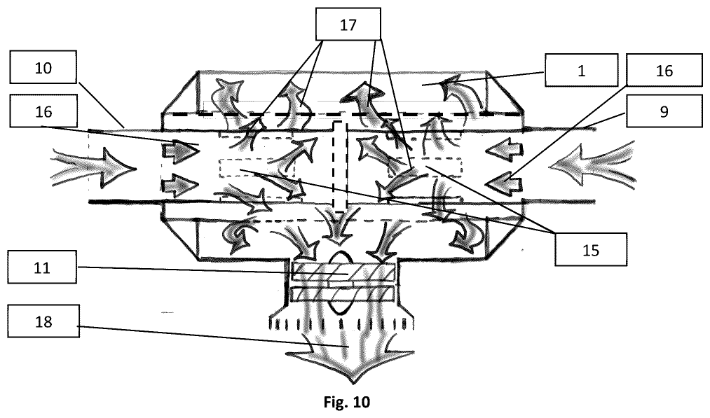

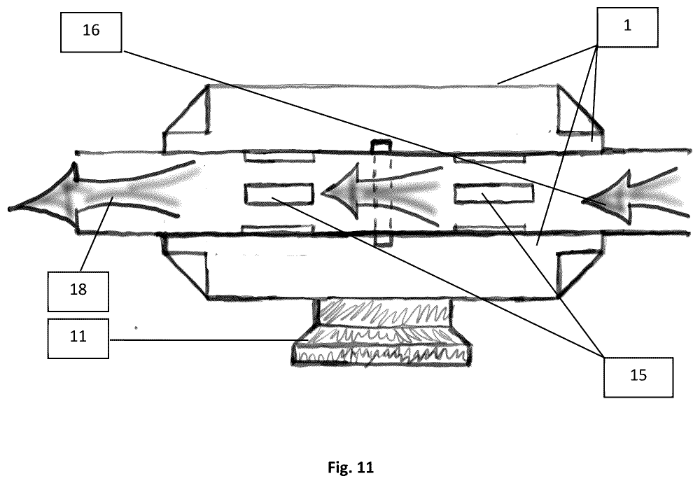

For VTOL operation, air is drawn in by injectors, compressed, and channeled into the plenum chamber which provides energized air to the ventral VTOL thrust assembly which further accelerates the air for vertical propulsion thrust. The PPD then goes into multi-mode transition by diverting air from the plenum chamber into rear injectors as they switch from injector mode to rearward thrust. This described synergistic process which is powered by electricity is what gives the Plenum Propulsion Drive the ability to provide power for flight while keeping the Earth healthy and green.

### CROSS-REFERENCE TO RELATED APPLICATIONS

This application claims the benefit of provisional patent application Ser. No. 63/349,546, filed Jun. 6, 2022.

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATION-BY-REFERENCE OF MATERIAL SUBMITTED ON A READ-ONLY OPTICAL DISC, AS A TEXT FILE OR AN XML FILE VIA THE PATENT ELECTRONIC SYSTEM

Not applicable

### BACKGROUND OF INVENTION

### Field of the Invention

The present invention relates to the Aerospace and Aviation industry or sector, particularly, Electric VTOL Aerospace/Aviation propulsion technology.

### Description of Related Art Including Information Disclosed Under 37 CFR 1.97 and 1.98

Not applicable.

### BRIEF SUMMARY OF THE INVENTION

The Augmentable Air Injected Plenum Propulsion Drive for Electric VTOL Operation and Flight, Plenum Propulsion Drive, or PPD for short, is the first eVTOL engine and/or propulsion system to employ the concept of opposing airflow and cyclic column compression of those opposing flow(s) to pressurize a plenum chamber for the purpose of augmenting, or amplifying, injected air to provide enhanced air/fluid power to an electric VTOL thrust system for VTOL operation and flight.

The PPD engine is a synergistic multimode propulsion system that utilizes opposing accelerated airflow to produce compression and augments that compression for vertical takeoff and landing. It then uses the same accelerated and dynamically compressed airflow to produce horizontal flight motion and thrust by transitioning the thrust tube assembly and reversing the fans of the two rear injectors for horizontal flight. The plenum chamber is central to the overall synergistic action. This is called cyclic column compression with a multi-mode application. Cyclic column compression is just a term to describe dynamic compression that takes place in the injectors and then in the plenum chamber. It is through cyclic column compression that columns of air are drawn in by the injectors and compressed. The injectors then pass that air into the plenum chamber and thereby have further dynamic compression of that air. The secondarily compressed air is then shunted to the Ventral VTOL Thrust Assembly for VTOL operation. Coupled with the action of the Thrust Tubes, Thrust Tube Sheaths, and multi-modal transition mechanisms, which will all be referred to as the Thrust Tube Assembly for clarity, the primary compression starts in the injectors and secondary compression is done in the plenum chamber where air is dynamically and continually forced in, accelerated, compressed, and then supplied to the Ventral VTOL Thruster Assembly for VTOL mode of operation. This condition is set until the system requires laminar in-line flow for horizontal flight mode and then transitional elements switch the PPD to horizontal flight mode.

### BRIEF DESCRIPTION OF THE SEVERAL VIEWS OF THE DRAWING(S)

1. An electric vertical takeoff and landing (eVTOL) engine and propulsion system comprising of:
I. a plenum chamber designed to be pressurized by opposing airflow and cyclic column compression;
II. injector mechanisms for drawing in air, compressing it, and directing it into said plenum chamber;
III. a ventral VTOL thrust assembly to receive air from the plenum chamber and accelerate it for vertical propulsion; and
IV. means for transitioning from vertical takeoff and landing operation to horizontal flight, including diverting air from the plenum chamber to rear injectors which transition from air intake to providing rearward thrust for horizontal flight, wherein said engine employs a synergistic process powered by electricity for providing flight power while minimizing environmental impact.

2. Wherein the eVTOL engine of claim 1 is multimodal, capable of both vertical takeoff, vertical landing and conventional horizontal flight.

3. Wherein the eVTOL engine of claims 1 and 2, further comprised of a propulsion system that is compact and modular, with comparative functionality and power for flight that is self-contained opposed to exposed rotors and propellers.

4. Wherein, the eVTOL engine of all preceding claims is configured as both a centralized and peripheral engine for flight propulsion.

5. Wherein, the eVTOL engine of all preceding claims, is further designed to be scalable, adaptable, capable of accommodating auxiliary power needs beyond propulsion.

6. Wherein, the eVTOL engine of all preceding claims is comprised of a dynamic compression plenum chamber that augments power for both horizontal flight and VTOL propulsion through the use of Air Injected Cyclic Column Compression with Opposing Flow.

7. Wherein, the eVTOL engine of all preceding claims consist of contained electric ducted fans that enhances safety and functionality by eliminating the need for exposed rotors.

8. Wherein, the eVTOL engine of all the preceding claims, utilizes a distinctive method for propelling an electric vertical takeoff and landing (eVTOL) vehicle.

9. Wherein, the method of claim 8 comprises of:
i. the employing of opposing airflow and cyclic column compression to pressurize a plenum chamber; and
ii. injecting air, compressing it, and channeling the compressed air into the plenum chamber; and
iii. thus, using the pressurized air in the plenum chamber to provide enhanced air power to a ventral VTOL thrust assembly for vertical propulsion;
iv. therefore allowing for the transition of the propulsion system for horizontal flight by diverting pressurized air from the plenum chamber to rearward thrust mechanisms,
a. wherein, the transitioning of sub-claim iv includes the reversing of the function of injectors by employing the same airflow used in vertical takeoff and landing to generate rearward thrust for horizontal flight.
v. whereby the methods described in claim 8 and claim 9 and all preceding sub-claims is able to facilitate flight with reduced environment impact by utilizing electricity to power the synergistic propulsion process.

10. Wherein, the eVTOL engine system and methods of all preceding claims for an electric vertical takeoff and landing (eVTOL) vehicle is herein described with reference to and as illustrated by the provided content and specifications.
